(19) United States
(12) Patent Application Publication
(10) Pub. No.: US 2009/0158267 A1
(43) Pub. Date: Jun. 18, 2009

(54) SYSTEM AND METHOD FOR INSERTING AUTHORIZED CODE INTO A PROGRAM

(75) Inventors: CHUNG-I LEE, Tu-Cheng (TW); CHIEN-FA YEH, Tu-Cheng (TW); BOR-CHUAN LIN, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/202,387

(22) Filed: Sep. 1, 2008

(30) Foreign Application Priority Data
Dec. 17, 2007 (CN) 200710203138.1

(51) Int. Cl. G06F 9/44

(52) U.S. Cl. 717/168

(57) ABSTRACT

A system and method for inserting authorized code into a program during execution of the program is provided. The system is installed in a computer. The computer includes a storage device for storing an IoC container, the program, the authorized code, and a configuration file. The system is configured for inserting the authorized code into the program during the execution of the program through the IoC container and the configuration file, so as to update at least one particular function of the program.

### BACKGROUND

1. Field of the Invention

Embodiments of the present disclosure relate to systems and methods for managing a program, and particularly to a system and method for inserting authorized code into a program.

2. Description of related art

Software programs are seldom perfect after the first development cycle, and consequently, may require continuous updates to fix problems in the software programs. Specifically, a program may require code updates in order to maintain, update, or extend particular functions corresponding to the inserted code. However, there is currently no apparatus, system, or method that can effectively and safely insert new authorized code into a program during the execution of the program.

Therefore, what is needed is a system and method for inserting authorized code into a program, which can effectively and safely insert the authorized code into the program during the execution of the program.

### SUMMARY

A system and method for inserting authorized code into a program during execution of the program in accordance with an exemplary embodiment is provided. The system is installed in a computer. The system includes a loading module, a setting module, a detecting module, an interrupting module, an inserting module, and at least one processor. The loading module is configured for loading an inversion of control (IoC) container from a storage device, and is configured for loading the program, the authorized code, and a configuration file from the storage device into the IoC container. The setting module is configured for setting a breakpoint of the program in the configuration file as an insertion point for inserting the authorized code. The detecting module is configured for detecting if frontal code of the breakpoint in the program has been executed through the IoC container. The interrupting module is configured for generating an interrupt signal through the IoC container so as to interrupt the execution of the program upon the condition that the frontal code has been executed. The inserting module is configured for inserting the authorized code into the program at the insertion point, and configured for executing the authorized code after the insertion of the authorized code, wherein the authorized code is configured to update at least one particular function of the program, and wherein the inserting module stores the updated program into the storage device. The at least one processor is configured for executing the loading module, the setting module, the detecting module, the interrupting module, and the inserting module.

Other systems, methods, features, and advantages of the embodiments will be drawn from the following detailed description of certain inventive embodiments of the present disclosure with references to the attached drawings, in which:

### BRIEF DESCRIPTION OF THE DRAWINGS

FIG. 1 is a block diagram of one embodiment of a system for inserting authorized code into a program during execution of the program;

FIG. 2 is a flowchart of one embodiment of a method for inserting authorized code into a program during execution of the program.

### DETAILED DESCRIPTION OF INVENTIVE EMBODIMENTS

All of the processes described below may be embodied in, and fully automated via, software code modules executed by one or more general purpose computers or processors. The code modules may be stored in any type of computer-readable medium or other computer storage device. Some or all of the methods may alternatively be embodied in specialized computer hardware.

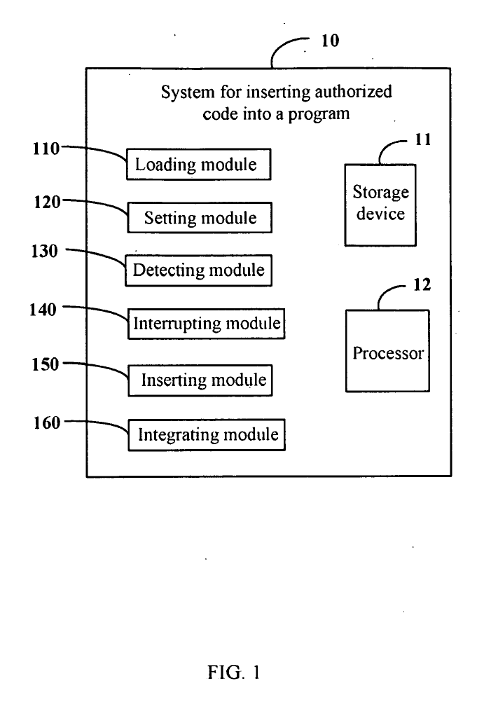

FIG. 1 is a block diagram of one embodiment of a system 10 for inserting authorized code into a program during execution of the program. The system 10 includes a storage device 11 and a processor 12. The insertion of authorized code in the program may refer to either maintaining, updating, or extending particular functions of the program. Maintaining, updating, or extending particular functions of a program may be collectively referred to as updating the program. Updating the program, in one embodiment, patches one or more particular functions of the program to be more secure, add functions, or fix problems in the program, for example.

The storage device 11 is a device that is used for storing any receivable data for the system 10. Depending on the embodiment, the storage device 11 can be used internally, such as a memory device, or externally, such as a hard disk. In one embodiment, the storage device 11 stores an inversion of control (IoC) container, the program, authorized code to be inserted in the program, and a configuration file.

The configuration file, in one embodiment, stores data in a “key=value” structure, which means each item of data has a name key with a value corresponding to the contents of the data. For example, one particular key=value structure may be defaultFont=Arial meaning that a default font for one item of data is the font Arial. By utilizing the IoC container, executions of different programs are seamlessly interchanged via the configuration file, and a program is modifiable during the execution of the program through different binding time tactics as will be further explained herein below.

In one embodiment, the system 10 may include a loading module 110, a setting module 120, a detecting module 130, an interrupting module 140, an inserting module 150, and an integrating module 160. The processor may execute one or more computerized code in the loading module 110, the setting module 1 20, the detecting module 130, the interrupting module 140, the inserting module 150, and the integrating module 160.

The loading module 110 is configured for loading the IoC container from the storage device 11, and is configured for loading the program, the authorized code, and the configuration file from the storage device 11 into the IoC container.

The setting module 120 is configured for setting a breakpoint of the program in the configuration file as an insertion point of the authorized code. In order to maintain, update, or extend particular functions of a program, code can be inserted into the program at the breakpoint.

The detecting module 130 is configured for detecting if frontal code of the breakpoint in the program has been executed through the IoC container.

The interrupting module 140 is configured for generating an interrupt signal through the IoC container so as to interrupt the execution of the program if the frontal code has been executed.

The inserting module 150 is configured for inserting the authorized code into the program at the insertion point, and is configured for executing the authorized code to maintain, update, or extend at least one particular function of the program after the insertion of the authorized code. The insertion module 150 is further configured for storing the updated program into the storage device 11.

The integrating module 160 is configured for executing next code of the breakpoint in the program after the execution of the authorized code.

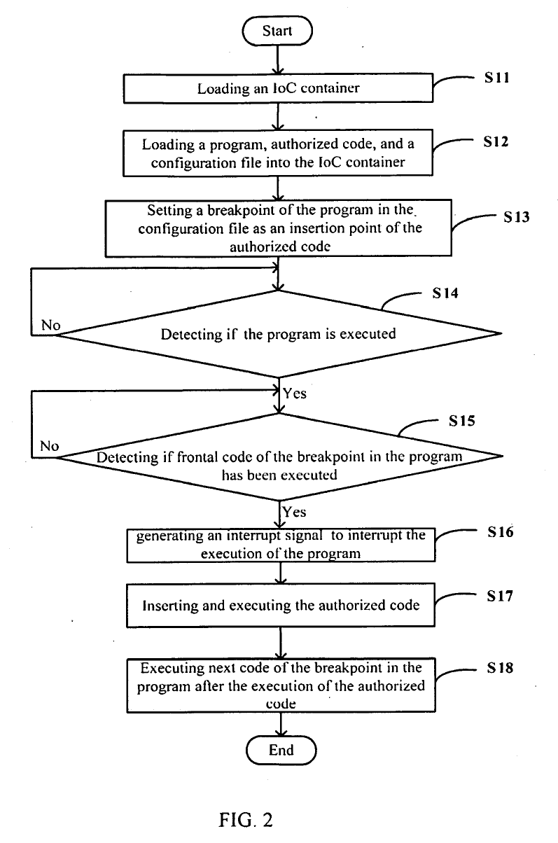

FIG. 2 is a flowchart of one embodiment of a method for inserting authorized code into a program during execution of the program. The method of FIG. 2 may be used to update a program so as to further secure a program from malicious attacks in one example. Depending on the embodiment, additional blocks may be added or removed, and the ordering of the blocks may be changed.

In block S11, the loading module 110 loads the IoC container from the storage device 11.

In block S12, the loading module 110 loads the program, the authorized code, and the configuration file from the storage device 11 into the IoC container.

In block S13, the setting module 120 sets a breakpoint of the program in the configuration file as an insertion point for inserting the authorized code.

In block S14, the detecting module 130 detects if the program is executed by the processor 12 through the IoC container.

If the program is not executed by the processor 12, the detecting module 130 continues to detect if the program is executed by the processor 12. Otherwise, if the processor 12 executes the program, in block S15, the detecting module 130 detects if frontal code of the breakpoint in the program has been executed through the IoC container.

If the frontal code has not been executed, the detecting module 130 continues to detect if the frontal code has been executed. Otherwise, if the frontal code has been executed, in block S16, the interrupting module 140 generates an interrupt signal through the IoC container to interrupt the execution of the program.

In block S17, the inserting module 150 inserts the authorized code into the program at the insertion point, and then executes the authorized code to maintain, update, or extend at least one particular function of the program after the insertion of the authorized code.

In block S18, the integrating module 160 executes next code of the breakpoint in the program after the execution of the authorized code. Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computing system for inserting authorized code into a program during execution of the program, the system comprising:
a loading module configured for loading an inversion of control (IoC) container from a storage device, and configured for loading the program, the authorized code, and a configuration file from the storage device into the IoC container;
a setting module configured for setting a breakpoint of the program in the configuration file as an insertion point for inserting the authorized code;
a detecting module configured for detecting if frontal code of the breakpoint in the program has been executed through the IoC container;
an interrupting module configured for generating an interrupt signal through the IoC container so as to interrupt the execution of the program upon the condition that the frontal code has been executed;
an inserting module configured for inserting the authorized code into the program at the insertion point, and configured for executing the authorized code after the insertion of the authorized code, wherein the authorized code is configured to update at least one particular function of the program, and wherein the inserting module stores the updated program into the storage device; and
at least one processor executing the loading module, the setting module, the detecting module, the interrupting module, and the inserting module.

2. The system as claimed in claim 1, further comprising:
an integrating module configured for executing next code of the breakpoint in the program after the execution of the authorized code.

3. The system as claimed in claim 1, wherein the IoC container enables executions of the authorized code and the program to be interchanged via the configuration file, and enables the program to be modifiable during the execution of the program through different binding time tactics.

4. The system as claimed in claim 1, wherein the configuration file is configured for storing data in a “key=value” structure.

5. A computer-implemented method for inserting authorized code into a program during execution of the program, the method comprising:
loading an IoC container from a storage device;
loading the program, the authorized code, and a configuration file from the storage device into the IoC container;
setting a breakpoint of the program in the configuration file as an insertion point for inserting the authorized code;
detecting if a processor of a computer executes the program through the IoC container;
detecting if frontal code of the breakpoint in the program has been executed through the IoC container if the processor executes the program;
generating an interrupt signal through the IoC container to interrupt the execution of the program if the frontal code has been executed;
inserting the authorized code into the program at the insertion point, and executing the authorized code to update at least one particular function of the program after the insertion of the authorized code;
storing the updated program into the storage device.

6. The method as claimed in claim 5, further comprising:
continuing to detect whether the processor executes the program, if the program is not executed by the processor.

7. The method as claimed in claim 5, further comprising:
continuing to detect whether the frontal code has been executed, if the frontal code has not been executed.

8. The method as claimed in claim 5, further comprising:
executing next code of the breakpoint in the program after the execution of the authorized code inserted.

9. The method as claimed in claim 5, wherein the IoC container enables executions of the authorized code and the program to be seamlessly interchanged via the configuration file, and enables the program to be modifiable during the execution of the program through different binding time tactics.

10. The system as claimed in claim 5, wherein the configuration file is configured for storing data in a “key=value” structure.

11. A computer-readable medium having stored thereon programs for inserting authorized code into a program during execution of the program which, when executed by a computer, cause the computer to perform a method, the method comprising:
loading an IoC container from a storage device;
loading the program, the authorized code, and a configuration file from the storage device into the IoC container;
setting a breakpoint of the program in the configuration file as an insertion point for inserting the authorized code;
detecting if a processor of the computer executes the program through the IoC container;
detecting if frontal code of the breakpoint in the program has been executed through the IoC container, if the processor executes the program;
generating an interrupt signal through the IoC container to interrupt the execution of the program, if the frontal code has been executed;
inserting the authorized code into the program at the insertion point, and executing the authorized code to update at least one particular function of the program after the insertion of the authorized code; and
storing the updated program in the storage device.

12. The medium as claimed in claim 11, wherein the method further comprises:
continuing to detect whether the processor executes the program, if the program is not executed by the processor.

13. The medium as claimed in claim 11, wherein the method further comprises:
continuing to detect whether the frontal code has been executed, if the frontal code has not been executed.

14. The medium as claimed in claim 11, wherein the method further comprises: executing next code of the breakpoint in the program after the execution of the authorized code inserted.
